(19) United States
(12) Patent Application Publication
(10) Pub. No.: US 2007/0121917 A1
(43) Pub. Date: May 31, 2007

(54) Method for automatically regulating volume of ringtone and communication device using the same

(75) Inventors: David Ho, Taipei (TW); Zhou Huang, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/494,481

(22) Filed: Jul. 28, 2006

(30) Foreign Application Priority Data
Jul. 29, 2005 (TW) 094125721

(51) Int. Cl. H04M 1/00; H04M 3/00

(52) U.S. Cl. 379/373.02

(57) ABSTRACT

The present invention discloses a method for automatically regulating the volume of a ringtone and a communication device using the same method, wherein a regulating program is installed in a control unit of the communication device, such that when the communication device receives an incoming call, the control unit detects an external sound signal through a sound detecting unit, and the regulating program compares a corresponding sound value converted from the external sound value with a predetermined standard value stored in the communication device and automatically regulates the corresponding sound value to an regulation value until the regulation value is greater than the corresponding sound value, and then plays a preset ringtone at the volume of the regulation value through a sound generating unit.

### FIELD OF THE INVENTION

The present invention relates to a method for automatically regulating the volume of a ringtone and a communication device using the same method, and more particularly to a method for automatically regulating the volume of a ringtone and a communication device using the same method that compare the sound value of the environment with a predetermined standard value and automatically adjust the volume of the ringtone according to the compared result.

### BACKGROUND OF THE INVENTION

As science and technologies advance, high-precision electronic products are used extensively to improve the quality of our life, and one of the communication devices such as a mobile phone is developed to make our life more convenient. Besides the functions of keeping in touch with friends or relatives at a remote end, sending or receiving short messages, writing E-mails, and maintaining a schedule, mobile phones also can be used for listening to music, playing games, performing calculations and taking pictures. The mobile phones usually come with a small, light and stylish design, so that users can perform the aforementioned operations conveniently.

If a traditional communication device receives an incoming call from another communication device, the following steps will be processed:

(Step 101) An incoming call processing unit produces an interrupt signal which is sent to a control unit in the communication device, such that after the incoming call processing unit in the communication device receives an incoming call, the communication device will enter an incoming call mode;

(Step 102) The control unit obtains a predetermined ringtone from a ringtone database and sends the ringtone to a sound generating element;

(Step 103) The ringtone set with a predetermined volume is played through a sound generating element until the incoming call is picked up by the user of the communication device or the incoming call processing unit no longer receives the incoming call, the procedure ends when the communication device exits the incoming call mode.

In a traditional communication device, the volume of the ringtone played by the communication device is set by the communication device user, so that if the communication device is carried from a quiet environment to a noisy environment, the volume originally set for the quiet environment will be too low for the noisy environment, and users may miss a call. On the other hand, if the communication device is carried from a noisy environment to a quiet environment, the volume originally set for the noisy environment will be too loud for the quiet environment, and thus the user has to frequently set the volume of the communication device with such inconvenient design, or else it may cause inconvenience to the user and nuisance to others. Therefore, finding a way of designing a communication device capable of automatically regulating the volume of a ringtone demands immediate attentions and feasible solutions.

### SUMMARY OF THE INVENTION

In view of the foregoing shortcomings of the prior art, the inventor of the present invention based on years of experience to conduct extensive researches and experiments and finally developed a communication device for automatically regulating the volume of a ringtone according to the sound value of the environment.

Therefore, it is a primary objective of the present invention to overcome the foregoing shortcomings by providing a method for automatically regulating a ringtone and a communication device using the same method, and a control unit of the communication device installs a regulating program, such that when the communication device receives an incoming call, the control unit detects an external sound signal through a sound detecting unit, and the regulating program compares a corresponding sound value converted from the external sound signal with a predetermined standard value stored in the communication device and automatically regulates the corresponding sound value to a regulation value until the regulation value is greater than the corresponding sound value and then plays the preset ringtone at the volume of the regulation value through a sound generating unit.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a flow chart of a prior art communication device entering into a call receiving status when receiving an incoming call signal;

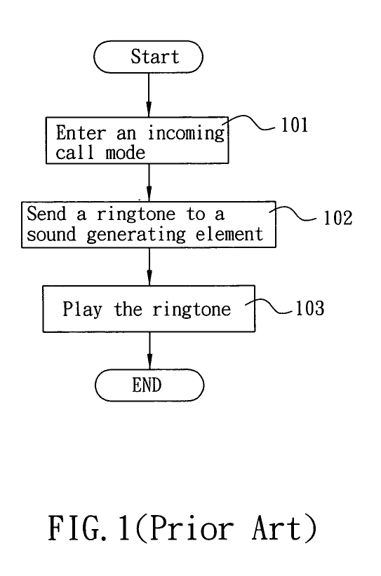

FIG. 2 is a circuit block diagram of a communication device of the present invention; and

FIG. 3 is a flow chart of a communication device automatically regulating a ringtone according to the sound value of the environment and entering into an incoming call mode when an incoming call signal is received.

### DETAILED DESCRIPTION OF THE PREFERRED EMBODIMENTS

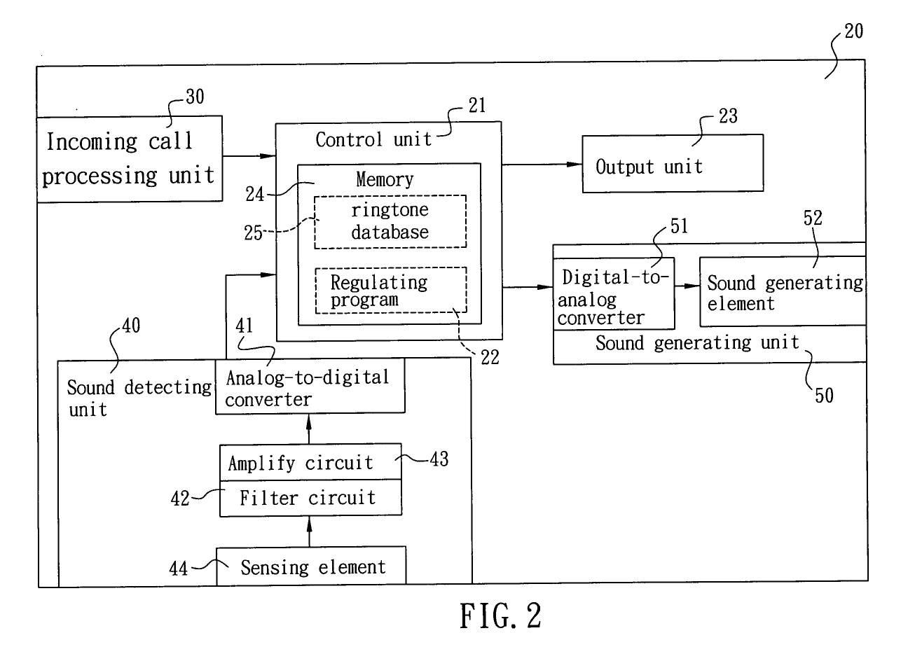

Referring to FIG. 2 for a method for automatically regulating the volume of a ringtone and a communication device using the same method in accordance with the present invention, the communication device 20 (such as a mobile phone) receives an incoming call from another communication device 20, and then the communication device 20 will carry out the following steps.

In Step 201, an incoming call processing unit 30 in the communication device 20 generates an interrupt signal and sends the interrupt signal to a control unit 21 in the communication device 20, such that the communication device 20 will enter an incoming call mode.

In Step 202, the control unit 21 obtains an external sound signal detected by a sound detecting unit 40 of the communication device 20 and converts the external sound signal into a corresponding sound value (or noise value).

In Step 203, a regulating program 22 installed in the control unit 21 determines whether or not the corresponding sound value is greater than a reset standard value provided by the regulating program; if yes, then process Step 204, or else process Step 205.

In Step 204, the regulating program 22 automatically adjusts the magnitude of a regulation value provided by the regulating program 22 until the regulation value is greater than the corresponding sound value, and then process Step 207.

In Step 205, the regulating program 22 determines whether or not the corresponding sound value is smaller than a low threshold value provided by the regulating program 22 ; if yes, process Step 206, or else the regulating program 22 automatically regulates the magnitude of the reset regulation value until the regulation value, is greater than the corresponding sound value, and then process Step 207.

In Step 206, the communication device 20 enters a mute mode and turns on an output unit 23 of the communication device 20, so that an output of the output unit 23 can remind the user of the communication device 20 about the current incoming call status, and then process Step 208.

In Step 207, the control unit 21 plays a predetermined ringtone at the volume of the regulation value through a sound generating unit 50, and then process Step 208.

In Step 208, the procedure is ended after the user of the communication device 20 receives an incoming call or the incoming call processing unit 30 no longer receives the incoming call, so as to exit the incoming call mode, and then process Step 202 again.

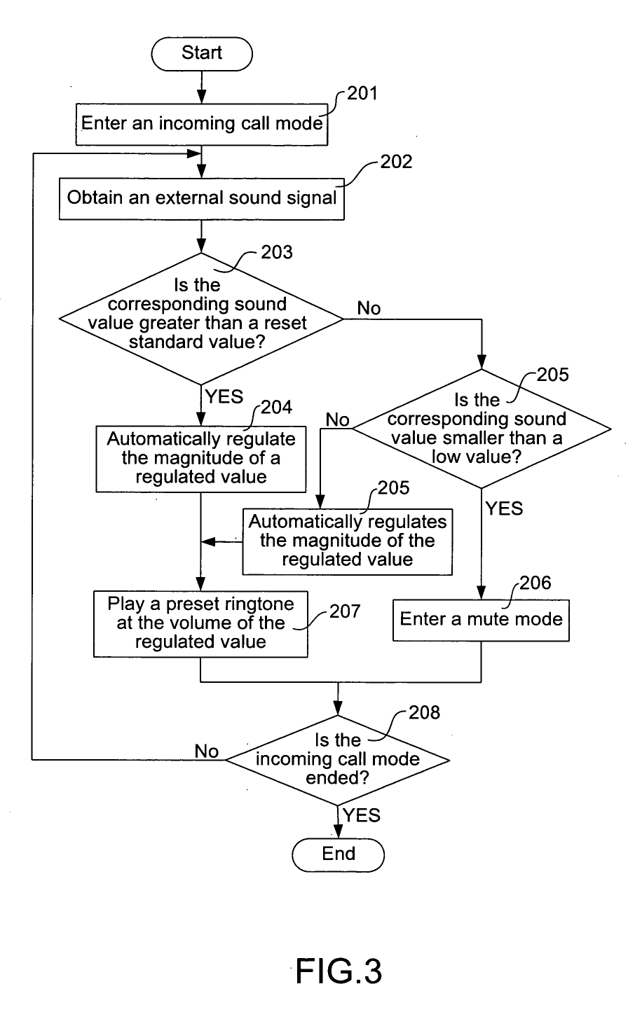

Referring to FIGS. 2 and 3, the regulating program 22 analyzes and compares the corresponding sound value with the standard value and automatically regulates the reset regulation value, and the difference of the standard value and the corresponding sound value and the magnitude of the corresponding sound value are default settings specified by the manufacturers of the communication device 20 or defined by users to meet the different user requirements.

Referring to FIG. 2, the sound detecting unit 40 comprises an analog-to-digital converter (ADC) 41, a filter circuit, an amplify circuit 43 and a sensing element 44, wherein the sensing element 44 detects an external sound signal (Voice) from the outside and then converts the external sound signal into an analog voltage signal (Wave), and then the amplify circuit 43 and filter circuit 42 process the signal, and the analog-to-digital converter 41 converts the signal into a corresponding sound value which is a digital value, and sends the corresponding sound value to the control unit 21 for further processing. However, the analog-to-digital converter (ADC) 41 of the invention could be built in the control unit 21, and thus the present invention can lower the cost and provide the advantage of better integration.

As shown in FIG. 2, the communication device 20 includes the control unit 21 and the output unit 23, wherein the control unit 21 is electrically coupled to each component and electronic circuit in the communication device 20 for the normal operations of the communication device 20, and the output unit 23 could be a display device or a vibrating motor. If the regulating program 22 determines that the corresponding digital sound value is greater than the standard value, the output of the output unit 23 will correspond to the change. For example, a display device projects a stronger light, and a continuous display of different colors of the display device or a stronger vibration of the vibrating motor is used to indicate the stronger light, so as to quickly and effectively remind the user of the communication device 20 about an incoming call status.

In FIG. 2, the control unit 21 further comprises a memory 24 for storing an operating system, an application program and the regulating program 22 required for the normal operations of the communication device 20 and executed by the control unit 21. Further, the memory 24 stores a ringtone database 25, and the ringtone database 25 records a plurality of ringtones which are preset by manufacturers or set or added by users of the communication device 20, and each ringtone in the ringtone database 25 can be selected by the user of the communication device 20, such that when the communication device 20 receives the incoming call, the sound generating unit 50 plays the ringtone to remind the user about the incoming call.

Further, the sound generating unit 50 comprises a digital-to-analog converter 51 (DAC) and a sound generating element 52 (such as a speaker) and the digital-to-analog converter 51 is provided for receiving a ringtone transmitted from the control unit 21 and converting the ringtone into a corresponding analog voltage signal (Wave) and sending the analog voltage signal to the sound generating element 52, and then the sound generating element 52 plays the sound (or voice).

While the invention herein disclosed has been described by means of specific embodiments, numerous modifications and variations could be made thereto by those skilled in the art without departing from the scope and spirit of the invention set forth in the claims.

What is claimed is:

1. A method for automatically regulating volume of a ringtone made by a communication device to signal an incoming call, wherein when said communication device receives an incoming call, said communication device performs the method comprising the steps of:
a control unit of said communication device enabling said communication device to enter an incoming call mode after said communication device receives said incoming call;
a sound detecting unit of said communication device obtaining an external sound signal and converting said external sound signal into a corresponding sound value;
said control unit receiving said corresponding sound value and utilizing a regulating program of said control unit to determine whether or not said corresponding sound value is greater than a standard value provided by the regulating program;
if said corresponding sound value is greater than the standard value, said regulating program automatically adjusting magnitude of a regulation value so that said regulation value is greater than said corresponding sound value; and
a sound generating unit playing a predetermined ringtone at volume of said regulation value.

2. The method of claim 1, wherein said communication device enters a mute mode, if said regulating program determines that said corresponding sound value is less than said standard value and also less than a low threshold value provided by the regulating program.

3. A communication device capable of automatically regulating volume of a ringtone made by the communication device to signal an incoming call, comprising:
a control unit comprising a regulating program which provides a standard value and a regulation value for regulating volume of a ringtone;
a sound detecting unit being electrically coupled to said control unit, the sound detecting unit converting an external sound signal into a corresponding sound value and then sending said corresponding sound value to said control unit for the regulating program to compare said corresponding sound value with said standard value and automatically adjust magnitude of said regulation value depending on the comparison result; and
a sound generating unit being electrically coupled to said control unit for playing a predetermined ringtone of said communication device at volume of said regulation value.

4. The communication device of claim 3, wherein said sound detecting unit comprises:
an analog-to-digital converter for converting said external sound signal which is an analog signal into said corresponding sound value which is a digital value.

5. The communication device of claim 3, wherein said sound generating unit is a display device or a vibrating motor.

6. The communication device of claim 3, wherein said control unit further comprises a memory for storing an operating system, an application program and said regulating program required for normal operations of said communication device.

7. The communication device of claim 6, wherein said memory stores a ringtone database that records a plurality of selectable ringtones.

8. The communication device of claim 3, wherein said regulating program further provides a low threshold value, and if said regulating program determines that said corresponding sound value is less than said standard value and also less than said low threshold value, said communication device enters a mute mode.

9. The communication device of claim 3, wherein if said regulating program determines that said corresponding sound value is greater than said standard value, said regulating program automatically adjusts magnitude of the regulation value so that the regulation value is greater than said corresponding sound value.
